(19) United States
(12) Patent Application Publication
(10) Pub. No.: US 2021/0012486 A1
(43) Pub. Date: Jan. 14, 2021

(54) IMAGE SYNTHESIS WITH GENERATIVE ADVERSARIAL NETWORK

(71) Applicant: Shenzhen Malong Technologies Co., Ltd., Shenzhen (CN)

(72) Inventors: Yawen HUANG, Shenzhen (CN); Weilin HUANG, Shenzhen (CN); Matthew Robert SCOTT, Shenzhen (CN)

(21) Appl. No.: 16/905,923

(22) Filed: Jun. 19, 2020

Related U.S. Application Data
(60) Provisional application No. 62/871,722, filed on Jul. 9, 2019.
(60) Provisional application No. 62/871,724, filed on Jul. 9, 2019.

(51) Int. Cl. G06T 7/00; G06T 11/00; G06N 3/08

(52) U.S. Cl. CPC G06T 7/0012; G06T 11/001; G06T 2207/20084; G06T 2207/20081; G06N 3/08

(57) ABSTRACT

Aspects of the technology described herein provide a system for improved synthesis of a target domain image from a source domain image. A generator that performs the synthesis is formed based on the texture propagation from the first domain to the second domain with a bidirectional generative adversarial network, which is trained for the texture propagation with a shape prior constraint.

### CROSS-REFERENCE TO RELATED APPLICATIONS

This application claims the benefit of U.S. Provisional Application No. 62/871,722, filed Jul. 9, 2019, entitled “Image Synthesis with Generative Adversarial Network,” and U.S. Provisional Application No. 62/871,724, filed Jul. 9, 2019, entitled “3D Image Synthesis System and Methods,” the benefit of priority of which is hereby claimed, and which is incorporated by reference herein in its entirety.

### BACKGROUND

There are many cases in which 2-D images, or frames, are applied in art, medicine, manufacturing, computer-aided design (CAD), animation, motion pictures, and computer-aided simulation, etc. There are many instances in which a user may wish to synthesize a frame from known data. To name a few examples: a data frame in a sequence of frames may be missing, corrupted, or inadvertently deleted. A subject may move during data collection, resulting in one or more distorted frames. A data collection system may operate in only one mode at a time, providing data in a single-mode, when additional modes of data are desired. An operator may wish to estimate what another mode of data collection would have looked like, given an input image.

To consider one such example in more detail: a clinician, while performing a recent, annual T-2 weighted Mill scan for a patient that presented with epileptic seizures, notices an indication of a tumor. When a T-1 weighted scan is also performed, the tumor's current morphology is revealed. However, the clinician would like to know about the tumor's growth rate, from a prior time, unfortunately, no T-1 weighted scan is available. The clinician can access the T-2 weighted Mill image depicting the same area from the prior year. The clinician would like to estimate morphology from the prior year. The clinician would like to estimate the T-1 weighted Mill data would have looked like, given the T-2 weighted Mill data that was collected in the prior year. Accordingly, there is a need in this and similar circumstances for a method that synthesizes, even with clinical accuracy, an image frame such as a T-2 weighted MRI image from an available image frame such as a T-1 weighted Mill image.

### BRIEF DESCRIPTION OF THE DRAWINGS

Aspects of the technology described in the present application are described in detail below with reference to the attached drawing figures, wherein:

FIG. 1 is an illustration of a user interface operative to control a system to generate a target domain image from a source domain image;

FIG. 2 is a diagram of a computer system configured to generate a target domain image from a source domain image, and to train a synthesizer;

FIG. 3 is a logical flow diagram illustrating a method of training a generator to produce a target domain image from a source domain image using domain matching, texture propagation, and a prior shape constraint;

FIG. 4 is a system diagram depicting exemplary components used in training a bidirectional generative adversarial network including a generator G that generates a target image from a source image using domain matching, texture propagation, and shape prior constraints;

FIG. 5 is a block diagram of an iterative method of training a generative adversarial network using entropy loss aggregated from one or more sources of loss;

FIG. 6 is a block diagram illustrating a method of defining classes for an application that makes use of a shape prior constraint;

FIG. 7 is a block diagram illustrating an exemplary system for image synthesis with generative adversarial networks; and

FIG. 8 depicts an embodiment of an illustrative computer operating environment suitable for practicing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As one skilled in the art will appreciate, embodiments of this disclosure may be embodied as, among other things: a method, system, or set of instructions embodied on one or more computer-readable media. Accordingly, the embodiments may take the form of a hardware embodiment, a software embodiment, or an embodiment combining software and hardware. In one embodiment, the present technology takes the form of a computer-program product that includes computer-usable instructions embodied on one or more computer-readable media.

This disclosure is related to the use of an Artificial Neural Network (ANN) such as a Convolutional Neural Network (CNN), or a Generative Adversarial Network (GAN) to perform image synthesis. An ANN is a computer processing module in hardware or software that is inspired by elements similar to those found in a biological neuron. For example, a variable input vector of length N scalar elements v₁, v₂, . . . vₙ are weighted by corresponding weights wᵢ, and to an additional bias b₀, and passed through hard or soft non-linearity function h( )to produce an output. In an embodiment, the nonlinearity is for example a sign function, a tanh function, a function that limits the maximum or minimum value to a programmable threshold output level, or a ReLU function. An ANN may produce output equal to h(v₁*w₁+v₂*w₂+ . . . +vₙ*wₙ+b₀). Such networks “learn” based on the inputs and a weight adjustment method. Weights may be adjusted iteratively based on evaluating the ANN over a data set while modifying the weights in accord with a learning object. Generally, an ANN with a plurality of layers is known as a deep network.

A Convolutional Layer is a layer of processing in a convolutional neural net hierarchy. A layer is a set of adjacent ANNs that have a small and adjacent receptive field. Typically a CNN has several defined layers. In an embodiment, a layer attribute such as identity, interconnection definitions, layer characteristics, layer type, number of layers may be set within a CNN component. The number of layers, for example, can be chosen to be 6, 16, 19, 38, or another suitable number.

A CNN is an ANN that performs operations using convolution operations, typically for image data. CNN may have several layers of networks that are stacked to reflect higher level neuron processing. A layer in a CNN may be fully connected or partially connected to a succeeding layer. One or more layers may be skipped in providing a layer output to a higher layer. The convolutions may be performed with the same resolution as the input, or a data reduction may occur through the use of a stride different from 1. The output of a layer may be reduced in resolution through a pooling layer. A CNN may be composed of several adjacent neurons, which process inputs in a receptive field that is much smaller than the entire image. Examples of CNN components include ZF Net, AlexNet, GoogLeNet, LeNet, VGGNet, VGG, ResNet, DenseNet, etc.

A Corpus is a collection of samples of data of the same kind, wherein each sample has two-dimensional (e.g., pixel), three dimensional (e.g., voxel), or N-dimensional extent. A collection may be formed for example from similar types of samples, that have a common set of attributes. Attributes of a sample may include the portion of anatomy (brain, head, heart, spine, neck, etc.), the mode or modality of the collection (FLAIR, T1-Weighted, T2-Weighted, PD-weighted, structural MRI, CT), the underlying technology (Magnetic Resonance Imaging (MRI), photograph, X-ray, Computer-Aided Tomography (CAT), Graphic Sequence, animation frame, game frame, simulation frame, CAD frame, etc.). Attributes further may include the date, subject condition, subject age, subject gender, technician collecting data, etc.

An entropy loss term is a term quantifying an amount of disorder. As an objective function argument, an entropy loss can be defined in various ways to meet an objective criterion that quantifies distance from an objective.

A GAN is a network of ANN elements that includes at least a generator network such as g( ) and a discriminator network such as dg( ). The generator network maps an input source domain sample x to form a synthesized output ŷ that approximates a target domain sample y. The discriminator network dg( ) judges whether a mapped output is real or fake. The generative adversarial network is then optimized by adjusting weights within both dg( ) and g( ) while maximizing the entropy at the output of the discriminator dg( ) but minimizing the entropy at the output of the generator g( ).

A bidirectional GAN may have dual-arranged synthesizers, that is, in addition to a first generator g( ) and a first discriminator dg( ), also includes a second generative network f( ) that operates in the reverse direction, approximating an inverse to the first generator g( ) by mapping an output target domain sample y to form a synthesized input \hat{x} that approximates a source domain sample x, A bidirectional GAN may also include a second discriminator df( ) that judges whether a pseudo-input is real or fake. In a bidirectional GAN, the mappings can be composed to form a pseudo sample that is based on both composed mappings. A pseudo-input x′ is given by f(g(x)). A pseudo-output y′ is given by g(f(y)).

A norm is a generally positive length measure over a vector space. In an embodiment, a norm comprises a semi-norm. A 2-norm is the square root of the sum of the squares of the vector elements. A 1-norm is the sum of the absolute values of the vector elements. A p-norm is a quantity raised to the 1/p power that includes a sum of the absolute values of the vector elements, wherein each absolute value of an element is raised to the p power. An infinity norm is the max over the vector elements of the absolute value of each vector element.

A Residual Neural Network (RNN) is an ANN that feeds the neural output to a layer beyond the adjacent layer, skipping one or more intervening layers, so that the receiving layer forms a result that includes a neural input from a non-adjacent preceding layer

A Segmentor is a network that segments the pixels of an image or voxels of a volume into a number of segment classes, e.g. class c1, c2, c3, . . . The output of a segmentor operating may be a set of class labels or a probability vector that reflects a probability that the pixel or voxel is a member of each of the segment classes.

Computer-readable media can be any available media that can be accessed by a computing device and includes both volatile and nonvolatile media, removable and non-removable media. By way of example, and not limitation, computer-readable media comprises media implemented in any method or technology for storing information, including computer-storage media and communications media. Computer storage media includes both volatile and nonvolatile, removable and non-removable media implemented in any method or non-transitory technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computing device.

Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

In one aspect, an apparatus is disclosed to synthesize images. A computer program operating in the memory of a computer executes instructions to use a first image generator network to synthesize an image. The first image generator network is formed based on training that creates a generator network capable of propagating textures that are present in a source image to a target image. Texture propagation may be achieved by using a bidirectional generative adversarial network that includes a first image generator network and a second image generator network that is an approximate inverse of the first generator network. To form the first generator network, the processing is performed over a first corpus of samples in a source domain and a first corpus of signals in a target domain.

In another aspect, a method is disclosed to train a first image generator network by receiving a corpus of source samples and a corpus of target samples. A first generator network estimate is formed based on texture propagation. Texture propagation propagates textures that are found in the source image to a target image. A bidirectional generative adversarial network is used to form a first generator network estimate and a second generator network estimate using information contained in a corpus of source samples and the corpus of target samples.

In another aspect, an apparatus is disclosed to synthesize images. The apparatus includes a first generator configured to operate on an input source image to produce an output target image. The first generator network was formed by texture propagation and a shape prior constraint. A bidirectional generative adversarial network is trained that comprises a first generator network and a second image generator network that is an approximate inverse to the first generator network. The two image generator networks are iteratively modified by processing training data (e.g., pixels or voxels) per an entropy loss that comprises a texture entropy loss term and a segmentation cross entropy loss term.

In an embodiment, a Brain Generative Adversarial Networks (BrainGAN) is used to explore multi-modality brain MRI synthesis. The BrainGAN is formulated by introducing a unified framework with new constraints which can enhance modality matching, texture details, and anatomical structure simultaneously. This tailors GANs towards the problem of Brain MRI allowing BrainGAN to learn meaningful tissue representation with rich variability of brain MRI. In addition to generating 3D volumes that are appearance-indistinguishable from real ones, adversarial discriminators and segmentors are modeled jointly, along with the proposed cost functions which force our networks to synthesize brain MRI more practically with realistic textures conditioned on anatomical structures. BrainGAN is evaluated on three datasets, where it consistently outperforms the state-of-the-art approaches by a large margin, advancing multi-modality image synthesis in brain MRI both visually and practically.

Image synthesis is the process of transforming image representation from a source domain into a target one. It is appealing to explore such technology since medical imaging is often expensive, time-consuming, and can be hampered by many factors e.g., obsolete equipment, variations among patients, changes in protocols, and vendors, making it hard to collect at a large scale. Furthermore, the diversity and advantages of multi-modality images (e.g. brain MRI) are of great importance to developing comprehensive models for clinical analysis and enriching data augmentation, which in turn improves the quality of diagnosis.

Generally, prior methods have difficulties in modeling complex patterns of irregular distributions with modality variations. Prior methods have difficulties in producing results with satisfactory quality. For example, the obtained representation either emphasizes fidelity of synthesized appearance or 3D shape structure, but not both. Other issues in prior methods include poor PSNR, contrast, conformity of shape structures, or spatial relationships.

In an embodiment, brain image generative networks (BrainGAN) are designed to customize a GAN-based framework for multi-modality brain MRI synthesis. A number of technical contributions associated with BrainGAN enable the task of multi-modality brain MRI synthesis efficiently and practically. Brain images are used in general to illustrate BrainGAN; however, the model or the technologies of BrainGAN is applicable to other tasks. Contributions include: extending GANs to feeding volumetric neuroimaging in a bidirectional generative-adversarial way subjected to the cycle-consistency constraint, allowing it to work in an unsupervised manner; introducing a unified framework with constraints that enhance domain matching, shape structure, and texture details simultaneously, allowing for learning meaningful tissue information for multi-modality MRI representation; formulating constraints within a modular GAN framework by using multiple loss functions, which drives a network to synthesize MRI images conditioned to the targeted anatomy. Experiments indicate consistently improved performance in images, e.g. of the brain.

A GAN comprises of a generator G and a discriminator D, which take noise samples z from a prior probability distribution p_{z}, and transform them by using a deterministic differentiable neural network G(·), where G(·) is learned to approximate the distribution of training samples x˜_{Pdata}. The mapping function G (z)˜_{Pg} is learned from a low-dimensional latent space to an image space by mapping p_{z} to the distribution of generated images p_{g}. D is optimized to discriminate between real images drawn from a distribution of _{Pdata} and the generated ones drawn from p_{g}. G is trained to imitate x, and is ideally supposed p_{g} to be identical with _{Pdata}. The learning process is iterated, by using a minimax objective between G and D, via [symbol] (G, D)= [symbol] _{x·Pdata} [log D(x)]+ [symbol] _{z˜Pz} [(log1−D(G(z)))], where GAN is usually trained with gradient-based methods through taking minibatch of fake generations via G and minibatch of real samples.

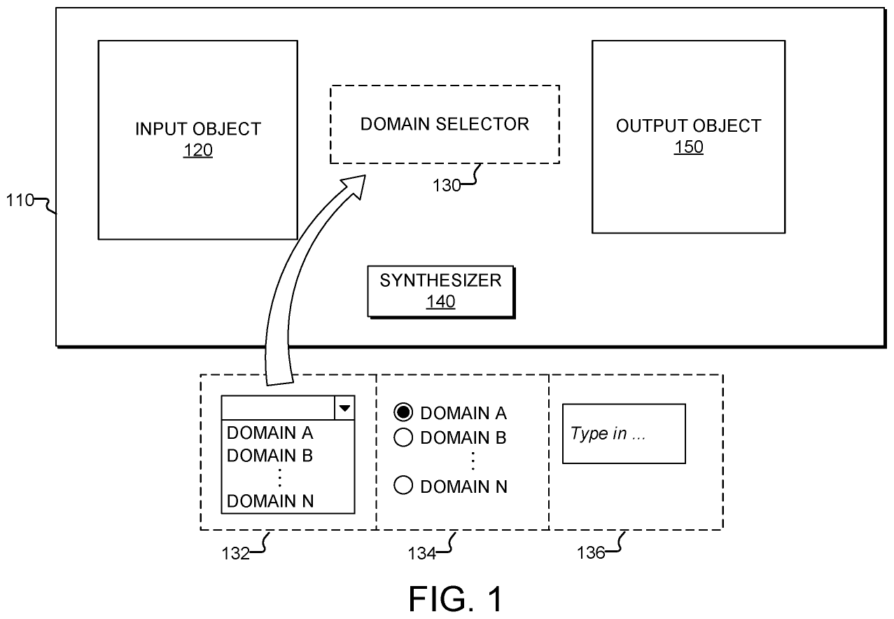

Turning now to FIG. 1, there is depicted therein a user interface operative to control a system to generate a target domain image from a source domain image. Computer display screen 110 presents graphical display area (GDA) 120 showing in input object, a domain selector control 130, an output object display area (OBDA) 150, and a synthesizer display area 140 that describes an underlying synthesizer 420.

In an embodiment, GDA 120 serves as a graphical control for inputting an object from a source domain and indicating the characteristics of the input object such as the associated source domain of the input object. In an embodiment, a header or file name extension of the input object indicates the type of source domain represented by the input object. An input object such as a source domain image is identified to synthesizer 420 as the input image from a source domain, e.g. Domain A. A user selects an object, e.g. by use of a computer pointing device, selecting an object from a source domain and dragging the object over GDA 120, thus informing synthesizer 420 of a desire to generate an output object to be displayed in OBDA 150.

Synthesizer display area 140 displays a description of a pre-determined synthesizer 420 that is capable of generating an output target domain image from an input source domain image. In an embodiment, a description includes an attribute of synthesizer 420 such as a title (e.g. BrainGAN23), a model developer name, a list of supported modes, an image context, several segment classes, a description of training data used, a date, etc. In an embodiment, synthesizer 420 has a predetermined output domain setting, such as Domain B, and so synthesizer 420 generates an output object in accord with the output domain setting, such as Domain B, and displays the output object in OBDA 150.

In an embodiment, domain selector control 130 comprises one or more of a list box 132, a radio button selector 134, and a domain input field 136. A user activates list box 132 by selecting the down-arrow list control and scrolling through several supported domains to select a particular member of the list such as “domain B” for output. List box 132 illustrates the availability of multiple different Domains: domain A, domain B, . . . domain N. Likewise radio button selector 134 allows the user to select a single output domain such as Domain A shown. Domain input field 136 allows the user to type in a description or designator for the desired output domain.

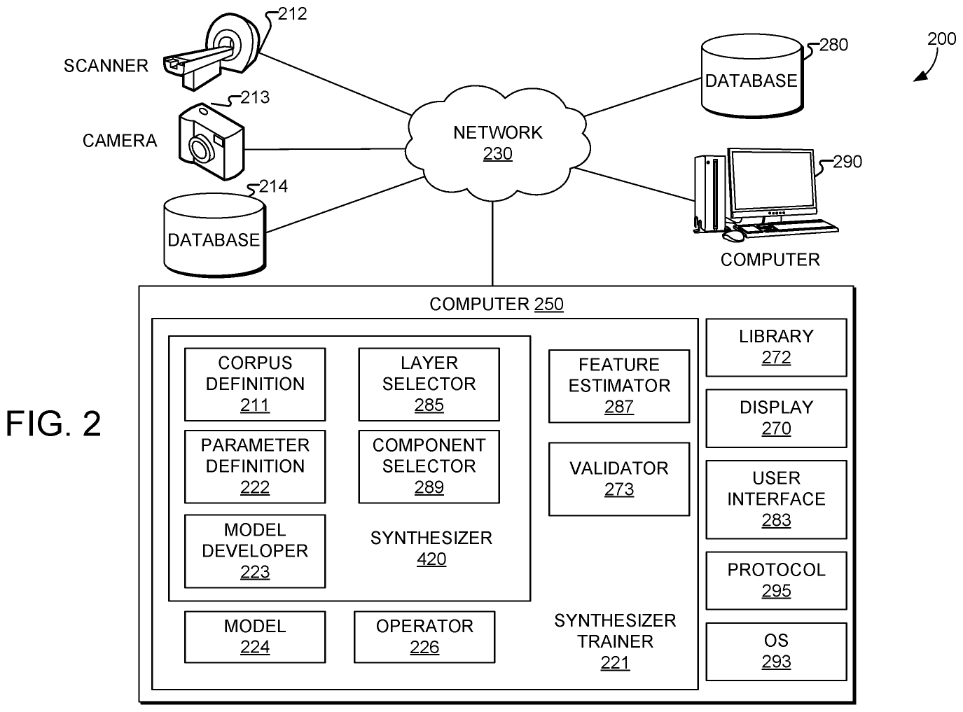

Turning now to FIG. 2 there is shown a diagram of a computer system operative to control a system to generate a target domain image from a source domain image. An operator program 226 runs in the memory of computer 250, responding to and invoking other programs that run in the memory of computer 250, in cooperation with operating system 293. Images are collected for synthesizer 420, e.g. by the operation of a sensor such as scanner 212 or camera 213, and images are stored, for example in local database 214 and/or remote database 280. An operator program 226 can browse and select images that are located on computer 250, on the local database 214 and the remote database 280 by making use of operating system 293, and protocol module 295. In an embodiment, network 230 comprises a Local Area Network (LAN) that connects database 214, camera 213, scanner 212 to computer 250, and a Wide Area Network (WAN) that connects computer 250 to computer 290 and database 280. In an embodiment, network 230 comprises a bus 810 that connects scanner 212 camera 213 and database 214 to computer 250, e.g. through I/O ports 850.

Operator program 226 functions to present to the user a display screen 110 using display module 270, and also to receive user indications from the user through user interface module 283. Operator program 226 retrieves the input source image from database 214 and displays a representation of the input source image in GDA 120. Operator program 226 reads the attributes of model 224 and presents a description of the attributes of model 224 to the user in synthesizer display area 140. Operator program 226 receives a user indication such as a domain selection received in domain selector control 130, indicating a desire to generate an output image in a determined target domain. Operator program 226 selects an appropriate model such as model 224 from a library 272 and loads the model 224 into synthesizer 420. Appropriate model selection considers one or more of a source image domain attribute, target domain image attribute, user indication of the desired model, a recently used model, user feedback indicating acceptable or unacceptable past behavior by a model, etc. In an embodiment, operator program 226 selects a performing model from library 272 that meets one or more user indicated aspects of a model. Operator program 226 uses the synthesizer 420 to synthesize an output target image, which the operator program 226 then displays in OBDA 150.

Library 272 generally includes all data and objects used or referenced by system 200. Portions of library 272 are residents for example in database 214 or database 280. Library 272 includes, for example, models, model definitions, model status, model context, supported model modes, and supported model classes, software, software development SDK's, software APIs, CNN libraries, CNN development software, etc.

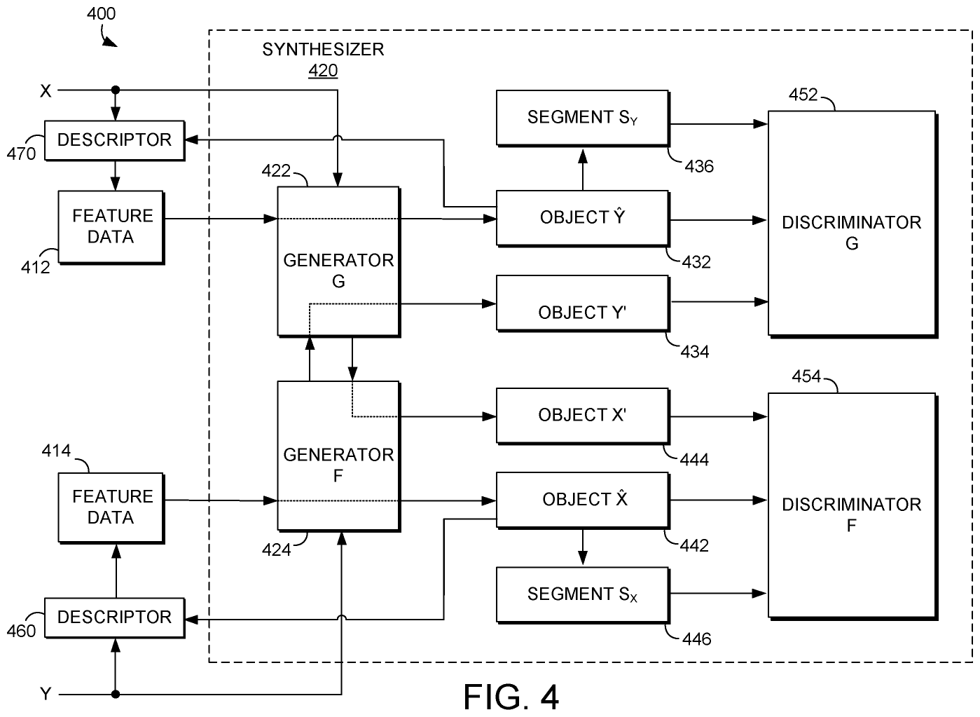

Synthesizer 420, when loaded with an appropriate model 224 is configured to synthesize a target domain image from a source domain image. Model 224 generally includes attributes that define an operational synthesizer 420 that includes weights and biases of one or more ANNs defining one or more of a generator 422, a generator 424, a segmentor 436, and a segmentor 446. The weights and biases of an ANN are stored in their usable form, e.g. through prior configuration and training by the operation of synthesizer trainer 221. Synthesizer 420 includes generator 422 and generator 424 that have been trained in a bidirectional generative adversarial network configuration. Since the training of generator 422 and generator 424 are simultaneously trained within a bidirectional generative adversarial network as described herein concerning FIG. 4, generator 424 will be an approximate inverse of generator 422. Generator 422 is based on training with texture propagation when synthesizer 420 has been loaded with a model 224 that provides weights and biases to generator 422 that has been trained using a method that influences a generator to perform texture propagation. Generator 422 is based on training with domain matching when synthesizer 420 has been loaded with a model 224 that provides weights and biases to generator 422 that has been trained using a method that influences a generator to perform domain matching. Generator 422 is based on training with a segmentation constraint when synthesizer 420 has been loaded with a model 224 that provides weights and biases to generator 422 that has been trained using a method that influences a generator to operate with a segmentation constraint.

Synthesizer trainer 221 is configured to define and configure synthesizer 420 for training. Synthesizer trainer 221, using component selector 289, selects individual components used in training such as descriptor 470, descriptor 460, generator 422, generator 424, segmentor 436, segmentor 446, discriminator 452 and discriminator 454. Component selector 289 presents the user with a component identity option for a synthesizer or trainer component, and receives an indication to define a component to have a particular form, such as a specific CNN to be used as a component. Layer selector 285 defines a layer to be used by the synthesizer trainer 221. Based on user selection, the layer selected is used within a user-selected context such as a layer to output to another layer, or a layer attribute definition, or a particular layer to be used for feature extraction, or to be used in a loss calculation. Parameter definition module 222 defines and stores parameter settings that are used for training based on user input. Examples of parameters include the relative weighting of loss calculations in a combined loss calculation, the stride number in a convolutional layer, the number of layers in a CNN, the type of layer in a CNN, the type of layer to be used (e.g. partially connected, fully connected, pooling, etc.), the size of the discriminator, the kernel size to be used, the activation method, learning rate, weight modification method, the solver to be used for training, the mini-batch size, etc. Model developer module 223 presents to the user the content of a model definition, describing the corpus defined by corpus definition module 211, the parameters defined by parameter definition module 222, the layers selected for use by layer selector 285, the components selected for use by component selector 289, the estimator selected by feature estimator 287. Model developer module 223 also displays the status of models as partially defined, completely defined, trained, validated, history of use, history of success, history of failure, etc.

In an embodiment, synthesizer 420 makes use of generator 422 or generator 424 with a particular operational configuration. In an embodiment, a generator consists of 3 convolutional layers with strides of 1, 2, 2 as the front-end, 6 residual blocks, 2 fractionally-strided convolutions with stride of ½, and 1 convolutional layer as the back-end with stride of 1. Convolution-BatchNorm-ReLU is applied except for the output layer which uses the tanh activation at the end. Each of the 6 residual blocks contains two convolutional layers with 128 filters on each layer. In one embodiment, 7×7×7 volumetric kernels are used for the first and last layers, and 3×3×3 kernels are used for the remaining layers.

In an embodiment, synthesizer 420 makes use of discriminator 452 or discriminator 454 that has a particular operational configuration. In an embodiment, instead of modeling a full image-sized discriminator, the patch size may be fixed as 70×70×70 in an overlapped manner, and use the stack of convolution-BatchNorm-Leaky ReLU layers to train the discriminative network. The discriminator is run convolutionally across the volumes, and the final results are computed by averaging all responses.

In an embodiment, synthesizer 420 makes use of segmentor 436 or segmentor 446 that has a particular operational configuration. In an embodiment, a segmentor is implemented as a deconvolution operation. In an embodiment, a layer skip architecture is employed for the segmentor. In an embodiment, all layers of the segmentor are adapted. In an embodiment, a segmentor is trained on a per-pixel basis. In an embodiment, a segmentor is validated with standard metrics.

Turning to FIG. 4, system 400 includes exemplary components used in training a bidirectional GAN including generator 422 (G) that generates a target image from a source image using domain matching, texture propagation, and shape prior constraints. Generator 422 receives a source sample X and generates a synthesized target Ŷ represented in object 432 that estimates a target domain sample. Generator 424 receives a target sample Y and generates a synthesized source ̂ represented in object 442 that estimates a source domain sample. A pseudo-source X′ represented by object 444 is formed by generator 424 operating on the output of generator 422. A pseudo-target Y′ represented by object 434 is formed by generator 424 operating on the output of generator 422.

Discriminator 452 operates with the knowledge of segment membership taken from segmentor 436 to determine if pseudo target object 434 and synthesized object 432 are real or fake. Discriminator 454 operates with knowledge of segment membership taken from segmentor 446 to determine if synthesized object 442 and pseudo source object 444 are real or fake. Descriptor 470 estimates features over samples X in the source domain corpus and stores the feature estimates in feature data store 412. A descriptor network such as 470 also estimates features by operating on the synthesized target Y and stores the feature estimates in feature data store 412. Descriptor 460 estimates features over samples Y in the target domain corpus and stores feature estimates in feature data store 414. A descriptor network such as descriptor 460 also estimates features by operating on synthesized source g and stores the feature estimates in feature data store 414.

Synthesizer trainer 221 uses descriptor 470 to form generator 422 based on texture propagation. Feature data at feature data store 412 is used in the formation of generator 422. The features stored in feature data store 412 influence the development of generator 422 and/or generator 424. Synthesizer trainer 221 uses descriptor 460 to form generator 424 based on texture propagation. Feature data at feature data store 414 is used in the formation of generator 424. The features stored in feature data store 414 influence the development of generator 424 and/or generator 422. In an embodiment, synthesizer trainer 221 effects feature influence by using a texture propagation entropy loss term as grounds to modify the values of the weights and biases present in an ANN contained within a generator, thus propagating the features from a source domain to a target domain in the creation of a generator. In an embodiment, descriptor 470 and descriptor 460 are implemented as CNN deep networks, such as visual geometry group (VGG) networks. Descriptors such as descriptor 470 and descriptor 460 comprise feature maps that are processed during training to preserve local textural details at convolutional layers. For example, by training with a texture propagation objective, generator 422 causes a source image to propagate textural details from a source image to a target image, thus achieving texture propagation.

In an embodiment, feature maps such as the feature maps of descriptor 460 or descriptor 470 are compared at a modeling layer L. In an embodiment, the feature maps at layer L are compared to other feature maps at layer L. In an embodiment, all feature maps at layer L and below are compared to all feature maps at layer L and below. The feature maps at layer L that model features of a target domain sample within descriptor 460 are compared to the feature maps at layer L that model features of a synthesized source domain sample (e.g. object 442), also within descriptor 460. The feature maps at layer L that model features of a source domain sample in descriptor 470 are compared to the feature maps at layer L that model a synthesized target domain sample (e.g. object 432), also within descriptor 470. An entropy loss term that quantifies an objective for optimization is calculated from the norm of the difference between the feature maps at layer L within Descriptor 470, added to a norm of the difference between the feature maps at layer L within Descriptor 460. In an embodiment, the 1-norm is used for such an entropy loss term.

Synthesizer trainer 221 uses segmentor 436 to effect a shape prior constraint in the development of the weights and biases of generator 422. In an embodiment, segmentor 436 extracts shape information from target domain samples such as object 432 and object 434. Likewise, segmentor 446 extracts shape information from source domain samples such as object 442. In an embodiment, synthesizer trainer 221 operates discriminator 452 and generator 422 by measuring segmented versions of Y over the corpus of target domain samples and segmented versions of the synthesized target Ŷ over the source domain corpus. In an embodiment, synthesizer trainer 221 operates discriminator 454 and generator 424 by measuring segmented versions of X over the corpus of source domain samples and segmented versions of synthesized source domain sample \hat{X} over the target domain corpus. In an embodiment, synthesizer trainer 221 effects shape prior constraint by using a shape prior entropy loss term as grounds to modify the values of the weights and biases present in an ANN contained within generator 422 and generator 424, thus forming generator 422 and generator 424 with, a shape prior constraint. In an embodiment, segmentor 436 and segmentor 446 forms a segmentation cross entropy term that calculates cross entropy loss across a set of classes. In an embodiment, the set of classes includes Cerebrospinal Fluid, Gray Matter, and White Matter.

Synthesizer trainer 221 effects domain matching by comparing the high-level features from layers in a deep network in the source domain and target domains to rectify a mismatch between source and target domains. In an embodiment, the high-level features of descriptor 470 that pertain to the source domain are compared to the high-level features of descriptor 460 that pertain to the target domain to calculate the distance between kernel mean embeddings. In an embodiment, a Maximum Mean Discrepancy (MMD) criterion is integrated into an adversarial training objective. In an embodiment, an empirical estimation is adopted to form a loss term that compares the high-level features of the source domain to the high-level features of a target domain based on a Gaussian kernel with a bandwidth parameter. In an embodiment, the MMD criterion is only adopted for features in the two highest layers. In an embodiment, the MMD criterion is adopted only incorporating features for the three highest layers. In an embodiment, the MMD criterion is adopted for the feature of all layers but the three lowest layers. In an embodiment, the MMD criterion is adopted for the features of all layers but the two lowest layers. In an embodiment, the MMD criterion is adopted based on a predetermined set of layers based on data structure analysis. In an embodiment, a domain matching criterion reduces domain discrepancy. In an embodiment, a domain matching criterion matches all orders of statistics for the high-level features that can be matched by using a loss term that affects the gradient search of the generative network through backpropagation. In an embodiment, an MMD criterion is adopted for a predetermined set of M layers.

Returning to FIG. 2, validator 273 can validate model 224. Validator 273 reads the model definition from model 224 and invokes a corpus definition module 211 to select appropriate images to be used in validating model 224. In an embodiment, model 224 includes both forward and reverse mappings. In an embodiment, both a forward validation corpus and a reverse validation corpus are defined. In an embodiment, a validation corpus is defined for source domain samples that are independent of the training set and encompass a quantity of at least 10% of the training data set size. In an embodiment, validator 273 operates incrementally as each new sample is generated. Model statistics in model 224 are updated to include user quality feedback. Validator 273 defines evaluation criteria and performs a validation over a corpus while tabulating results pertaining to the validation evaluation criteria. Validation results are presented to a user for approval. Once approved by a user, the corpus is then validated and placed into library 272 and labeled as a validated model for future use. In an embodiment, validator 273 uses evaluation criteria that comprise a score of results based on a user review of synthesized images. In an embodiment, validator 273 uses evaluation criteria that quantitatively evaluate synthesized images using PSNR or SSIM values.

Feature estimator 287 operates to estimate features of a source domain sample or a target domain sample. In an embodiment, features of a domain are determined by feature estimator 287 based on a selected CNN that is trained with a corpus of domain samples. In an embodiment, features are extracted by feature estimator 287 by using statistical feature extraction methods such as nonparametric feature extraction, or unsupervised clustering. In an embodiment, features are extracted by feature estimator 287 using a descriptor neural network such as descriptor 470 or descriptor 460. In an embodiment, feature estimator 287 estimates the features of a descriptor CNN over a corpus from a domain.

Protocol module 295 operates to perform link, network, transport, session, presentation, and application layer protocols. Using protocol module 295, computer program modules on computer 250 send and receive data from sensors such as scanner 212, camera 213, local database 214, and remote database 280, and with computer programs running on remote computer 290 through network 230.

Synthesizer trainer 221 may perform training over a corpus of source domain samples and a corpus of target domain samples. Corpus definition module 211 receives a user indication of the scope of training samples to define a corpus of source domain samples to be used in training. For example, a user selects samples of attributes of a domain such as 3D, brain, healthy, T1-weighted MRI, etc. Corpus definition module 211 stores these selected attributes. Corpus definition module 211 then searches database 214 or database 280 to find samples that meet the domain criteria supplied by the user, reflecting one or more of the selected attributes. The results of the search are presented to the user in descending order of level of matching the selected attributes, and the user indicates which samples are to be included in training. Corpus definition module 211 similarly receives a target domain description from a user and based on user indication or approval defines a corpus of target domain samples. In an embodiment, a user selects an incremental estimation option, and a corpus of samples is incrementally increased by one sample as each new sample is supplied to the system, resulting in an incremental modification of the weights and biases of an ANN within synthesizer 420.

In an embodiment, given a set of unpaired training samples in the source domain and the target domain, X={Xᵢ}ᵢ^{S}=1 [symbol] ^{m×n×t×s} and y={Yⱼ}ⱼ^{T}=1 ∈ [symbol] ^{m×n×t×s} respectively, the task is to construct a bidirectional framework, i.e., X↔ [symbol] , that allows for data transformation between two domains in an unsupervised manner. m and n are the dimensions of axial view of volumetric images, t denotes the size of images along the z-axis, while S and T are the numbers of samples in the training sets from the source and target domains. Two mappings are constructed: G:X→ [symbol] and F: [symbol] →X in the voxel space, and then the generations of G and F can be represented as Ŷ=G(X) and \hat{X}=F(Y). The corresponding discriminators D_{G} and D_{F} are constructed to distinguish the fake generations associated with G and F.

In an embodiment, a system uses a bidirectional GAN. To transform an image from X ∈ X to Y ∈ [symbol] a GAN model includes a mapping function G:X→ [symbol] is formulated with the expected target Ŷ=G(X), along with a discriminator D_{G}. Similarly, the inverted task can be learned via F: [symbol] →X having \hat{X}=F(Y) judged by the discriminator D_{F}. Instead of working with 2D stacks, in an embodiment, 3D volumes are directly used here to ensure the intrinsic sequential information between consecutive slices. The adversarial losses of our bidirectional mapping functions are jointly expressed in the volumetric space via [symbol] _{b}(D_{G},D_{F},G,F)= [symbol] (G,D_{G})+ [symbol] (F, D_{F}). [symbol] _{b} forms a unified framework between two domains and extends the unidirectional volumetric GANs into a bidirectional system.

In an embodiment, the adversarial losses of both mapping functions are jointly expressed in the volumetric space, e.g., according to Eq.1.

[symbol]

_{b}(D_{G}, D_{F}, G, F)= [symbol] _{Y·Pdata(Y)}[log D_{G}(Y)]+ [symbol] _{˜Pdata(X)}[log(1−D_{G}(G(X)))]+ [symbol] _{x˜Pdata(X)}[log D_{F}(X)]+ [symbol] _{Y˜Pdata(Y)}[log (1−D_{F}(F(Y)))] Eq. 1

This function forms a simple closed loop between two losses which extends the volumetric GANs into a dual learning manner and joint representations into a unified framework. In the unsupervised dual learning problem, one typical property is to force both learnings from each other to produce the pseudo-source. This is done by generating X′for task X→ [symbol] and Y′ for task [symbol] =X respectively, where X′=F(Ŷ)=F(G(X)) and Y′=G(\hat{X})=G(F(Y)).

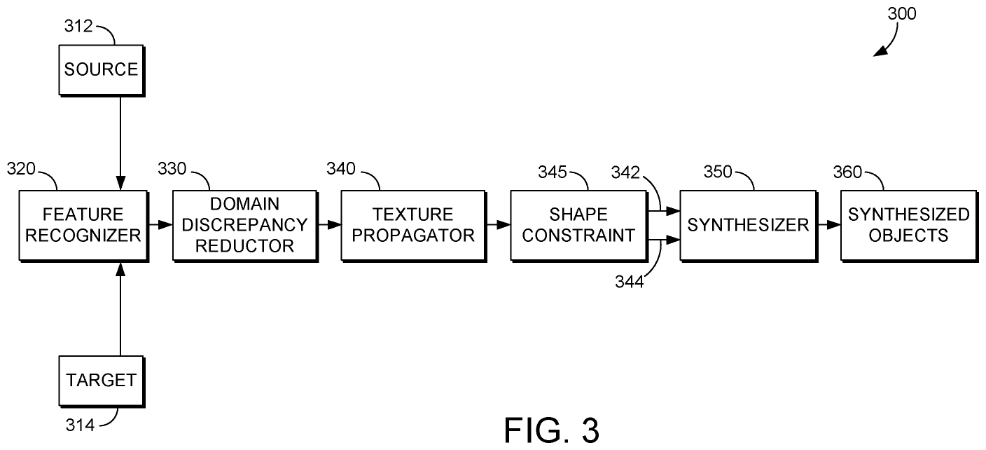

Turning to FIG. 3, a flow diagram illustrates a method 300 operable within synthesizer trainer 221 to train a generator to produce a target domain image from a source domain image using domain matching, texture propagation, and a shape prior constraint. At 312 the method receives a corpus of source samples. At 314 the method receives a corpus of target samples. Generally, method 300 operates through training that calculates an objective function and determines weights and biases of one or more ANNs using a bidirectional generative adversarial network to produce an estimate at synthesizer 350, such as synthesizer 420 including generator 422 and generator 424 that can generate synthesized objects 360.

In an embodiment, synthesizer 420 is formed by incorporating one or more of a domain discrepancy reduction computed at block 330, a texture propagation computed at block 340, a shape prior constraint computed at block 345, a bidirectional constraint, and a cycle consistency constraint. In an embodiment, synthesizer 350 is formed by iteratively modifying weights and biases within an ANN performing generator 422 and within an ANN performing generator 424.

At block 320, the corpus of source samples and the corpus of target samples are used to produce estimates of features in the source domain and to produce estimates of features in the target domain. In an embodiment, the features of the synthesized source domain and the features of the synthesized target domains are estimated at block 320. In an embodiment, at block 320, the features are recognized within descriptor 470 which may include a CNN with six or more layers. In an embodiment, at block 320, the features are recognized within descriptor 460 which may include a CNN with six or more layers. In an embodiment, at block 320, only the features of a predetermined number M of the layers are selected for a constraint. In an embodiment, the M selected layers are the highest layers. In an embodiment, the M selected layers are the lowest layers. In an embodiment, the M selected layers are determined by statistical feature evaluation that determines the importance of the selected features for transfer.

At block 330 a discrepancy between the source and the target domains is reduced. A set of layers is determined in the source domain and in the target domain, e.g. a set of M layers in CNN descriptor 470, and CNN descriptor 460. At block 330 a method is performed to reduce the domain discrepancy, such as applying an MMD criterion. In an embodiment, the distance between the mean embeddings of the features of the selected M layers is normed to form an entropy loss term.

At block 340, texture propagation is employed to form estimates of a first generator network and a second generator network, wherein the first generator network and the second generator network are configured in a bidirectional generative adversarial network such as synthesizer 420. In an embodiment, at block 340 feature correlations are made. In an embodiment, feature correlations are made in a deep neural network. In an embodiment, the features of the source domain and the synthesized target domain are modeled in descriptor 470. In an embodiment, the features of the target domain and the synthesized sourced domain are modeled in descriptor 460. In an embodiment, feature correlations include comparing the feature maps of a synthesized target at layer L to the feature maps of a source domain at a layer L. In an embodiment, a comparison comprises a first difference term formed by subtracting the feature maps pertaining to a source domain at a layer L of descriptor 470 from the feature maps pertaining to a synthesized target domain at a layer L of descriptor 470. In an embodiment, feature correlations include comparing the feature maps of a synthesized source at layer L to the feature maps of a target domain at layer L. In an embodiment, a comparison comprises a second difference term formed by subtracting the feature maps pertaining to a target domain at a layer L of descriptor 460 from the feature maps pertaining to a synthesized source domain at a layer L of descriptor 460. In an embodiment, the feature maps of layer L include all feature maps of a descriptor less than or equal to a layer L. In an embodiment, a texture loss term is formed by the sum of a norm of the first difference term and a norm of the second difference term. In an embodiment, a 1-norm is used in a texture loss term.

At block 345 a shape prior constraint is applied in the formation of image generator network 422. Segmentor 436 extracts shape information from synthesized object 432, and target domain sample Y. Segmentor 446 extracts shape information from a source domain sample and synthesized source object 442. In an embodiment, at block 345, a segmentation cross entropy loss term is calculated that quantifies cross entropy loss across predetermined segment classes. In an embodiment, the classes include a set of brain tissue classes including one or more of the border, background, gray matter (GM), cerebrospinal fluid (CSF), and white matter (WM). In an embodiment, training of synthesizer 420 results in the production of two output synthesizers. At block 342 a first generator 422 is produced for synthesizer 420 that produces target domain images from source domain images. At block 344, a second generator 424 is produced for synthesizer 420 that produces source domain images from target domain images.

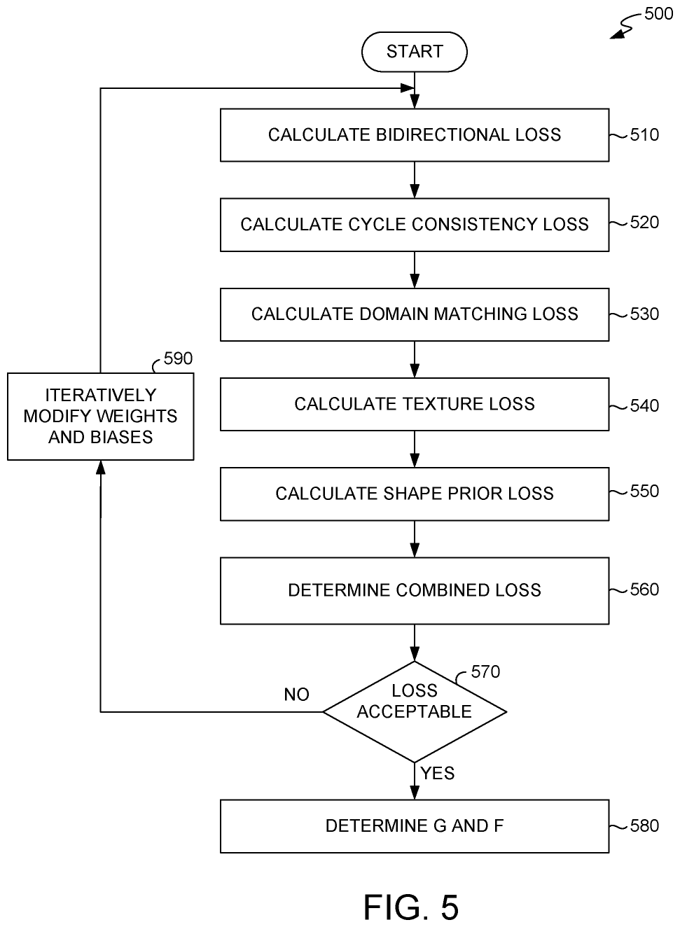

At synthesizer 350, an estimate of synthesizer 420 is formed, including generator 422 and generator 424 by incorporating information from a source domain corpus and information from a target domain corpus into synthesizer 420 through training. An exemplary method 500 for training synthesizer 420 by synthesizer trainer 221 is shown in FIG. 5. Synthesizer trainer 221 presents a description of a model definition that includes “fully defined, but not trained” together with a graphical control for initiating training. When a user selects the graphical control, preparatory training operations are performed and method 500 is invoked.

Preparatory training operations include, for example, the synthesizer trainer 221 placing model definitions for the selected model into memory, determining fixed components, determining components to be trained, determining batch size, determining a component training sequence (if any), initializing weights and biases into components to be trained, selecting a batch of source samples from the source sample corpus and a batch of target samples from the target sample corpus, and applying selected batches to synthesizer 420. In an embodiment, a learning rate of 0.0002 is set. In an embodiment, different corpus pairs of source corpus and target corpus are identified for each step of training.

In an embodiment, a training sequence includes a descriptor training step, a segmentor training step, and a bidirectional GAN training step. In a descriptor training step descriptors 460 and 470 are trained by an iterative process to approximate the features of the source domain in a descriptor for the source domain and in a descriptor for the synthesized source domain, and also to approximate the features of the target domain in a descriptor for the target domain and in a descriptor for the synthesized target domain. The descriptors for the source and target domains are then fixed, and the descriptors for the synthesized target domain and synthesized source domain are initialized to be used in the bidirectional GAN training step. In the segmentor training step segmentors 436 and 446 are trained by an iterative process to correctly identify the classes defined. Segmentors 436 and 446 are then fixed for the bidirectional training step. In the bidirectional training step the descriptor of the synthesized sourced domain, the descriptor of the synthesized target domain, generator 422, generator 424, discriminator 452, and discriminator 454 are all identified as components to be trained, and the method of 500 is invoked.

In an embodiment, synthesizer trainer 221 determines that descriptor 470, descriptor 460, generator 422, generator 424, segmentor 436, segmentor 446, discriminator 452, and discriminator 454 are all components to be trained, and no component training sequence is defined, and the method of 500 is invoked.

Method 500 generally involves calculating one or more loss functions at 510, 520, 530, 540, 550, 560, determining if the loss is acceptable at 570, and if not iterating by returning to the beginning of the iteration loop after modifying weights and biases at 590. When the loss is acceptable generator 422 and generator 424 have been determined at 580. A new batch of source domain samples and a new batch of target domain samples are taken into the iteration loop and applied to system 400 before new loss calculations are performed, e.g. at a return to 510. At 590 the weights and biases of the components being trained are modified in each iteration of the loop to search for an improved set of weights and biases. In an embodiment, the modification is made in accordance with stochastic gradient descent. In an embodiment, the Adam solver is used for training. In an embodiment, the mini-batch size of 1 is used.

At 570 a test is performed to determine if the loss computed is acceptable. In an embodiment, the test simply determines if more iteration loops were planned, if yes, then the test determines that loss is not acceptable and the method proceeds to 590. In an embodiment, the average loss over some number of iterations is calculated, and when the average loss has been approximately equal for some period of time, the loss is determined to be acceptable and the method proceeds to 580.

At 510 a bidirectional loss L_{b} is calculated. At 520 a cycle consistency loss L_{c} is calculated. To address the ill-poseness of an unsupervised setting of unpaired domain images, a volumetric cycle-consistency loss is used, to add constraints on the mutual translations. That is, by generating X′ for task X→ [symbol] and Y′ for task [symbol] →X, where X′=F(Ŷ)=F(G(X)) and Y′=G(\hat{X})=G(F(Y)). The volumetric cycle-consistency can be modeled as Eq. 2 under the l₁ distance.

L_{c}(X,G, [symbol] ,F)= [symbol] _{X·P}_{_{data}}_{(X)}∥X−F(G(X))∥₁+ [symbol] _{Y˜p}_{_{data}}_{(Y)}∥Y−G(F(Y)∥₁ Eq. 2

At 530 a domain matching loss is calculated. The cycle-consistency constraint can drive unpaired image mapping from one modality to the other and vice versa, by assuming that the distributions of two modalities are approximately domain invariant. The latent representations disentangle explanatory factors of domain variations, but the multi-modality domain discrepancy still remains. Therefore, the assumption is not strong enough for very heterogeneous domain matching. To rectify the mismatch and design a model toward better generalization on diverse datasets, the solution space can be constrained by introducing a domain matching term. In an embodiment, the Maximum Mean Discrepancy (MMD) criterion is used and integrated into the adversarial training objective, e.g., according to Eq. 3, where [symbol] _{MMD} is defined to measure distance in a squared reproducing kernel Hilbert space (RKHS) between the kernel mean embeddings of X and y [symbol] . ø(·) is a nonlinear feature mapping which induces a RKHS [symbol] , while A^{X} and A^{Y} are the deep features of X and Y learned from a VGG network, e.g. employed at descriptor 470 and at descriptor 460.

[symbol]

_{MMD}(A^{x}, A^{Y}) [symbol] ∥ [symbol] ₓ[ø(A^{x})]− [symbol] _{y}[ø(A^{y})]∥_{H}² Eq. 3

However, in the original MMD, the expectations of A^{X} and A^{Y} are difficult to calculate in an infinite-dimensional kernel space ø(·). An empirical estimation may be obtained according to Eq. 4, where

$$k ( {A}^{X} , {A}^{Y} ) = {e}^{\frac{- {‖ {A}^{X} - {A}^{Y} ‖}^{2}}{σ}}$$

denotes the Gaussian kernel defined on A^{X} and A^{Y} with bandwidth parameter σ.

$${ℒ}_{MMD} ( {A}^{X} , {A}^{Y} ) = \frac{1}{{S}^{2}} {\sum }_{i = 1}^{S} {\sum }_{j = 1}^{S} k ( {A}_{i}^{x} , {A}_{j}^{X} ) + \frac{1}{{T}^{2}} {\sum }_{i = 1}^{T} {\sum }_{j = 1}^{T} k ( {A}_{i}^{Y} , {A}_{j}^{Y} ) - \frac{2}{ST} {\sum }_{i = 1}^{S} {\sum }_{j = 1}^{T} k ( {A}_{i}^{x} , {A}_{j}^{Y} ) \qquad Eq . 4$$

In an embodiment, the domain matching loss is the empirical estimator at a subset of M layers using a parameter σ. In an embodiment, a bandwidth parameter is adaptively modified. In an embodiment, a bandwidth parameter is estimated from scatter calculations over a feature space.

At 540 a texture loss is calculated. In addition to synthesize the main context of an image such as that involving a brain, a key issue in multi-modality synthesis is to ensure that texture details in an image from the source modality can be propagated correctly into the target. However, GANs-based approaches generally suffer from the limitation of preserving textural details for image synthesis, while meaningful texture information is of great importance for clinical analysis of brain Mitt To enhance such detailed information, a texture loss is designed to adopt feature correlations in a deep network and preserve local textural details at convolutional layers, e.g., according to Eq. 5, where N is the VGG network, e.g. descriptor 460 or descriptor 470, l represents the features maps of a certain layer.

Lₜ(G,F)= [symbol] _{X˜p}_{_{data}}_{(X)}∥Nₗ(G(X))−Nₗ(X)∥₁+ [symbol] _{Y˜p}_{_{data}}_{(Y)}∥Nₗ(F(Y))−Nₗ(Y)∥₁ Eq. 5

In an embodiment, the VGG network has six layers. In an embodiment, all feature maps are included in Lₜ for all layers of an underlying VGG network, deployed for example at descriptor 470 and at descriptor 460.

At 550 a shape prior constraint is calculated. In an embodiment, shape prior information is used for image analysis. In an embodiment, shape prior information is used through semantic segmentation approaches. In an embodiment, shape information is extracted for multimodality brain images. It can provide rich semantic context and meaningful insights that assist other related tasks for the better understanding anatomical structure of the brain. For multi-modality brain Mill synthesis, a key desirable ability is to preserve strong anatomical structure across different image modalities of the same subject. In an embodiment, shape prior information is obtained by feeding generations from G and F into their discriminators D_{G} and D_{F}, and two segmentors Sₓ and S_{Y}. The shape prior constraint can be formulated, e.g., according to Eq. 6, where Lₛ(·) refers to a segmentation cross entropy loss, and eᵢ^{k} denotes one-hot encoding corresponding to the i-th example volume within the k-th tissue class.

$${L}_{S} ( G , {S}_{χ} , F , {S}_{y} ) = {E}_{y ∼ {p}_{data} ( y )} [ - {\sum }_{i = 1} {\sum }_{k = 1} ( {e}_{i}^{k} log ( {S}_{Y} ( {Y}_{i} ) ) + {e}_{i}^{k} log ( {S}_{Y} ( G ( {X}_{i} ) ) ) ) ] + {E}_{x ∼ {p}_{data} ( x )} [ - {\sum }_{i = 1} {\sum }_{k = 1} ( {e}_{i}^{k} log ( {S}_{x} ( {X}_{i} ) ) + {e}_{i}^{k} log ( {S}_{x} ( G ( {Y}_{i} ) ) ) ) ] \qquad Eq . 6$$

At 560 an objective function is determined as a goal of iterative training. In an embodiment, the objective function is determined as a combined loss function. An iteration model In an embodiment, considers domain matching, texture details, and anatomical structure, e.g. for brain MRI synthesis. A loss can be formulated as a minimax adversarial objective, e.g., according to Eq. 7, where δ, γ, λ and β are the weight parameters which balance the cycle-consistency loss, MMD, shape prior loss and texture loss, respectively.

$$\begin{matrix}min \\ G , F\end{matrix} \begin{matrix}max \\ {D}_{G} {D}_{F}\end{matrix} {L}_{b} ( {D}_{b} , {D}_{F} , G , F ) + δ {L}_{c} ( X , G , Y , F ) + γ {L}_{MMD} ( {A}^{X} , {A}^{Y} ) + γ {L}_{s} ( G , {S}_{X} , F , {S}_{Y} ) + β {L}_{t} ( G , F ) \qquad Eq . 7$$

In an embodiment, a mini-batch of size 1 is used with manually set the weight parameters as: δ=10, γ=0.3. λ=1, β=10. In an embodiment, the above equation can be optimized by alternatively maximizing the discriminators, and minimizing a combination of bidirectional mapping loss, with multiple designed constraints.

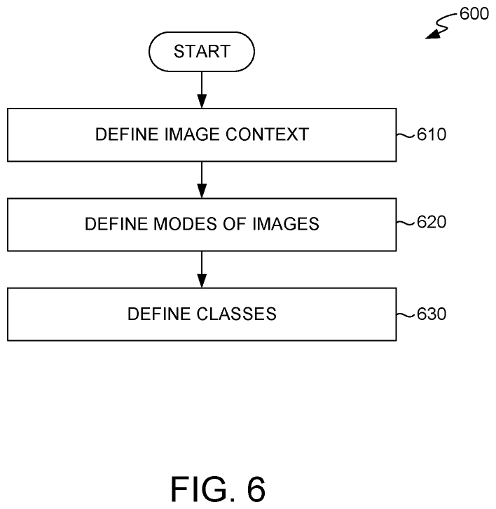

Turning to FIG. 6 there is depicted in 600 a method of defining classes for an application that makes use of a shape prior constraint. In an embodiment, at 610, a category is defined for an image context in which a user desires to synthesize an image. Examples of context include the format of the samples (e.g. 2-D or 3-D), and the application area (e.g. applied in art, medicine, manufacturing, computer-aided design, animation, motion pictures, and computer-aided simulation, etc.). Examples of context also include the scope of the images. For example, 3D medicine samples might be drawn from a particular portion of anatomy (brain, head, heart, spine, neck, etc.) At 620 the modes of the images to be transformed are defined. For example, in medicine, modes of data collection are identified to represent a different domain of representation that samples might be converted between, (e.g. FLAIR, T1-Weighted, T2-Weighted, PD-weighted, structural MRI, CT). At 630, the classes are defined. Each defined mode is analyzed with data structure analysis to categorize different segments of the images that are desired to be transformed. For example, in brain medical images the classes are determined to be CSF, GM, and WM. In an embodiment, a source and target domain are chosen to model the characteristics a particular type of subject. For example, an adolescent female of 14 years is modeled over a T1-weighted MRI scan as the source domain and with a T2-weighted MRI scan as the target domain by searching database 214 and database 280 for female adolescent scans of both types of scans. A first search step determines a first number of source domain samples available for a type of source domain and a second number of target domain samples available for a type of target domain. A user is presented with the available totals, and the user has the opportunity to narrow or broaden the definition of type.

In one embodiment, experiments were performed to evaluate BrainGAN over three datasets: IXI (http://brain-development.org/ixi-dataset/), NAMIC Multimodality (http://hdl.handle.net/1926/1687), and BraTS (https://www.med.upenn.edu/sbia/brats2018/data.html) datasets. The IXI dataset contains 578 healthy subjects, while the NAMIC dataset includes 10 normal controls and 10 schizophrenic cases. The BraTS 2015 dataset has 220 brain tumor subjects. In one embodiment, BrainGAN is evaluated in three scenarios, which were designed based on the observed mismatch between source and target domains: (1) PD [symbol] T2 on the IXI dataset, (2) T1 [symbol] T2 on the NAMIC dataset, (3) FLAIR [symbol] T1 on the BraTS.

Quantitatively, the selection may include 239 unpaired PD-w and T2-w MRI from the IXI dataset, 8 unpaired T1-w, T2-w acquisitions from the NAMIC dataset, and 90 unpaired T1-w and FLAIR data for training. The remaining data: 100 (IXI), 4 (NAMIC), and 40 (BraTS) are used for testing. For FCN, both real scans and the synthesized results may be used to produce three main brain tissue classes: Cerebrospinal Fluid (CSF), Gray Matter (GM), and White Matter (WM), giving the averaged quantification of a brain volume. The tissue prior probability templates are based on averaging multiple automatic segmentation results in the standard image space, and thus there is no guarantee that CSF, GM, and WM will exactly follow other methods. For evaluation criteria, one may use PSNR, SSIM and Dice score to compare the results.

BrainGAN may be compared against other synthesis methods. One may use default values for them, empirically to reach the best performance on a given set. In one embodiment, both visual and quantitative results are evaluated in different cases. First, visual results are compared with PSNR and SSIM values. BrainGAN can generate sharper anatomical structure and more clear texture details, resulting in significantly higher PSNR and SSIM values than previously proposed approaches. Second, when to compare the performance of T1 [symbol] FLAIR and T2 [symbol] PD transformations, BrainGAN obtained clear performance improvements over the other methods in the term of PSNR and SSIM. Third, quantitative evaluations were on three datasets. BrainGAN consistently outperforms recent approaches, by a large margin. In addition, it also has clear improvements over a GAN-based baseline demonstrate the advantages of a proposed embodiment of brain-specific constraints.

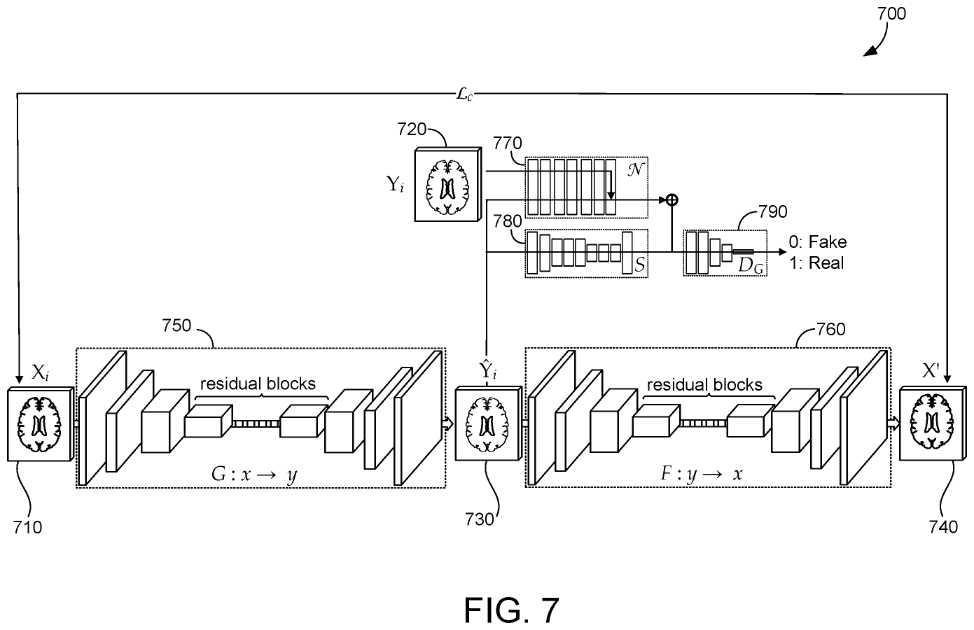

FIG. 7 is a block diagram illustrating an exemplary system for image synthesis with generative adversarial networks. Existing approaches for image generation lack realism. System 700 uses GANs in a novel way for multi-modality brain MRI synthesis. System 700 introduces a unified framework with new constraints, which can enhance modality matching, texture details, and anatomical structure simultaneously. System 700 is configured to learn meaningful tissue representation with rich variability of brain MRI. Specifically, system 700 models adversarial discriminators and segmentors jointly, along with the disclosed cost functions which force the networks to synthesize brain MRI more practically with realistic textures conditioned on anatomical structures. System 700 generates transferable modality representation, with rich semantic features, textural details, and anatomical structure preservation. System 700 uses the three new constraints to effectively customize GANs for brain MRI synthesis. Resultantly, system 700 can generate 3D volumes that are appearance-indistinguishable from real ones. As discussed previously, when evaluated on various datasets, system 700 consistently outperformed the state-of-the-art approaches by a large margin, which suggested that system 700 has advanced multi-modality image synthesis in brain MRI both visually and practically. Although system 700 is discussed in the context of brain image, system 700 is applicable to other tasks or other images.

In system 700, GANs are extended to feeding volumetric neuroimaging in a bidirectional generative-adversarial way subjected to the cycle-consistency constraint, allowing it to work in an unsupervised manner. Further, system 700 uses a unified framework with new constraints that enhance domain matching, shape structure, and texture details simultaneously, allowing for learning meaningful tissue information for multi-modality MRI representation. The proposed constraints are formulated within a modular GAN framework by using multiple loss functions, which drives system 700 to synthesize MM images conditioned to the targeted anatomy.

In various embodiments, GANs consist of a generator G and a discriminator D, which take noise samples z from a prior probability distribution P_{z}, and transform them by using a deterministic differentiable neural network G⊙, where G⊙is learned to approximate the distribution of training samples x˜_{P}_{_{data}}. The mapping function G(z)˜_{Pg} is learned from a low-dimensional latent space to an image space by mapping [symbol] _{z} o the distribution of generated images [symbol] _{g}. D is optimized to discriminate between real images drawn from a distribution of [symbol] _{data} and the generated ones drawn from [symbol] _{g}. G is trained to imitate x, and is ideally supposed [symbol] _{g} to be identical with [symbol] _{data}. The learning process is iterated, by using a minimax objective between G and D, via [symbol] (G,D)= [symbol] _{x˜Pdata}[log D(x)]+ [symbol] _{z˜Pz[(log1-D(G(z)))]}, where GAN is usually trained with gradient-based methods through taking minibatch of fake generations via G and minibatch of real samples.

In system 700, network 750 (denoted as G) and network 760 (denoted as F) are configured to collectively perform bidirectional mapping functions using 3D volumes 710 and 720 (denoted as X and Y). 3D volume 730 (denoted as Ŷ) denotes the first generated results while 3D volume 740 (denoted as X′) is its dual generations. Network 790 (denoted as D_{G}) is the discriminator corresponding to G. Network 780 (denoted as S) is a segmentor, and [symbol] _{c} denotes the cycle-consistency loss. Network 770 (denoted as N) is a deep convolutional network for object recognition (e.g., VGG network).

Given a set of unpaired training samples in the source domain and the target domain, X={Xᵢ}ᵢ^{S}=1 ∈ [symbol] ^{m×n×t×S} and [symbol] ={Yⱼ}ⱼ^{T}=1 ∈ [symbol] ^{m×n×t×S} respectively, system 700 is to construct a bidirectional framework, i.e., X← [symbol] , that allows for data transformation between two domains in an unsupervised manner. Using m and n to denote the dimensions of an axial view of volumetric images, t to denote the size of images along the z-axis, S and Tto denote the numbers of samples in the training sets from the source and target domains, two mappings (G:X→ [symbol] and F: [symbol] →X) are constructed in the voxel space. The generations of G and F may be represented as Y =G(X) and X =F(Y). The corresponding discriminators D_{G} and D_{F} are constructed to distinguish the fake generations associated with G and F.

Regarding the bidirectional generations, to transform an image from X ∈ X to Y ∈ [symbol] using GANs model, a mapping function G:X→ [symbol] is formulated with the expected output Ŷ=G(X), along with a discriminator D_{G}. Similarly, the inverted task can be learned via F: [symbol] →X having \hat{X}=F(Y) judged by the discriminator D_{F}. System 700 enables 3D volumes to be used directly to ensure the intrinsic sequential information between consecutive slices. The adversarial losses of the bidirectional mapping functions are jointly expressed in the volumetric space via [symbol] _{b}(D_{G},D_{F},G,F)= [symbol] (G, D_{G})+ [symbol] (F, D_{F}). [symbol] _{b} forms a unified framework between two domains and extends the unidirectional volumetric GANs into a bidirectional system.

Further, to address issues of an unsupervised setting of unpaired domain images, system 700 uses a volumetric cycle-consistency loss, to add constraints on the mutual translations. By generating X′ for task X→ [symbol] and Y′ for task [symbol] →X, where X′=F(Ŷ)=F(G (X)) and Y′=G(\hat{X})=G(F(Y)). The volumetric cycle-consistency may be modeled, e.g., according to Eq. 2 above under the l₁ distance.

Regarding domain matching, the cycle-consistency constraint can drive unpaired image mapping from one modality to the other and vice versa, by assuming that the distributions of two modalities are approximate domain invariant. The latent representations disentangle explanatory factors of domain variations, but the multi-modality domain discrepancy remains.

To rectify the mismatch and design a model toward better generalization on diverse datasets for heterogeneous domain matching, system 700 constrains the solution space by introducing a domain matching term. The Maximum Mean Discrepancy (MMD) criterion is integrated into the adversarial training objective, e.g., according to the Eq. 3 above.

This equation is defined to measure distance in a squared reproducing kernel Hilbert space (RKHS) between the kernel mean embeddings of X and [symbol] , Ø⊙ is a nonlinear feature mapping which induces a RKHS [symbol] , while A^{X} and A^{Y} are the deep features of X and Y learned from VGG network. However, in the original MMD, the expectations of A_{X} and A_{Y} are difficult to calculate in an infinite-dimensional kernel space Ø⊙. Instead, the empirical estimation may be obtained, e.g., according to the Eq. 4 above.

Regarding texture propagation, in addition to synthesize the main context of the brain, a key issue in multi-modality synthesis is to ensure that texture details in an image from the source modality can be propagated correctly into the target. However, GANs-based approaches commonly suffer from the limitation of preserving textural details for image synthesis, while meaningful texture information is of great importance for clinical analysis of brain MRI. To enhance such detailed information, system 700 uses a texture loss which adopts feature correlations in a deep network and preserve local textural details at convolutional layers, e.g., according to the Eq. 5 above.

Further, shape prior information is critical to brain image analysis and semantic segmentation approaches, for extracting shape information from multi-modality brain images. It can provide rich semantic context and meaningful insights that assist other related tasks for better understanding the anatomical structure of the brain. For multi-modality brain MRI synthesis, a key desirable ability is to preserve strong anatomical structure across different image modalities of the same subject. To do that, system 700 feeds generations from G and F into their discriminators D_{G} and D_{F}, and two segmentors S_{X} and S_{Y}, as illustrated in FIG. 4. The segmentors may be implemented as deconvolution operations. Therefore, the shape prior constraint can be formulated, e.g., according to the Eq. 6 above.

System 700 jointly considers domain matching, texture details and anatomical structure for brain MRI synthesis. The objective function in system 700 can be formulated as a minimax adversarial objective, e.g., according to Eq. 7 above. Further, this object function can be optimized by alternatively maximizing the discriminators, and minimizing a combination of bidirectional mapping loss, with multiple designed constraints.

System 700 contains generators, discriminators, and segmentors. In one embodiment, the generator consists of 3 convolutional layers with strides of 1, 2, 2 as the front-end, 6 residual blocks, 2 fractionally-strided convolutions with stride of ½, and 1 convolutional layer as the back-end with stride of 1. Convolution-BatchNorm-ReLU is applied except for the output layer which uses the tanh activation at the end. Each of the 6 residual blocks contains 2 convolutional layers with 128 filters on each layer. In one embodiment, 7×7×7 volumetric kernels are used for the first and last layers, and 3×3×3 for the remaining layers. In one embodiment, instead of modeling a full image-sized discriminator, the discriminator in system 700 uses the patch size as 70×70×70 in an overlapped manner, and uses the stack of convolution-BatchNorm-Leaky ReLU layers to train the discriminative network. In one embodiment, the discriminator is configured to run convolutionally across the volumes, and the final results are computed by averaging all responses. In one embodiment, a learning rate of 0.0002 is set for the segmentor. In one embodiment, Stochastic Gradient Descent is applied with the Adam solver for training. In one embodiment, system 700 uses a mini-batch of size 1, and manually sets the weight parameters as: δ=10, γ=0.3. λ=1, β=10.

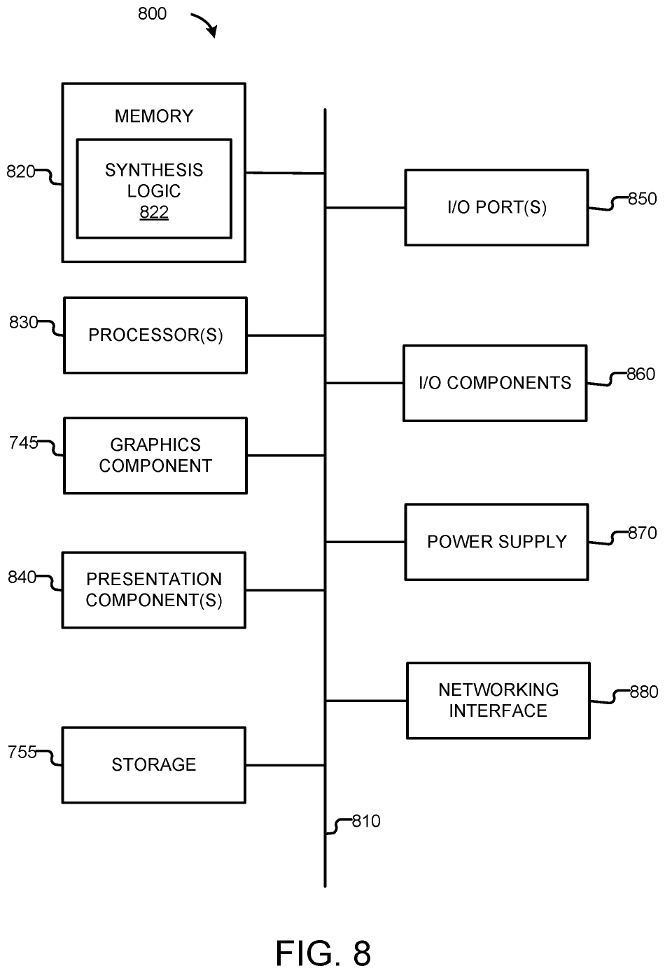

Turning briefly to FIG. 8, there is shown architecture detail of one example embodiment of computer 250 that has software instructions for storage of data and programs in computer-readable media. Computing system 800 is representative of a system architecture that is suitable for computer systems such as computer 250 or 290. Components of computing system 800 are generally coupled together, for example by bus 810. One or more CPUs such as processor(s) 830, have internal memory for storage and couple to memory 820 that contains synthesis logic 822, allowing processor(s) 830 to store instructions and data elements in system memory 820, or memory associated with an internal graphics component, which is coupled to presentation component(s) 840 such as one or more graphics displays. Synthesis logic 822 enables computing system 800 to become a special-purpose computer, such as performing various disclosed processes for synthesizing 2D or 3D images.

In an embodiment, an external graphics component 745 is provided in addition to or in place of a graphics component internal to processor(s) 830 and couples to other components through bus 810. A Bios flash ROM is contained within processor(s) 830. Processor(s) 830 can store instructions and data elements in storage 855, which includes internal disk storage or external cloud storage, or make use of I/O port 850 to store on a USB disk, or make use of networking interface 880 for remote storage. User I/O components 860 such as a communication device, a mouse, a touch screen, a joystick, a touch stick, a trackball, or keyboard, coupled to processor(s) 830 through bus 810 as well. The system architecture depicted in FIG. 8 is provided as one example of any number of computer architectures, such as computing architectures that support local, distributed, or cloud-based software platforms, and are suitable for supporting computer 250. In an embodiment, computing system 800 is implemented as a microsequencer without an ALU. In an embodiment, computing system 800 is implemented as discrete logic that performs the functional equivalent in discrete logic such as a custom controller, a custom chip, Programmable Array Logic (PAL), a Programmable Logic Device (PLD), an Erasable Programmable Logic Device(EPLD), a field-programmable gate array (FPGA) a macrocell array, a complex programmable logic device, a hybrid circuit. Processor(s) 830 are extensible to any I/O device through I/O port(s) 850. The computing system 800 is supplied power by power supply 870. In an embodiment, a graphics processor in graphics component 745 performs computing with software rather than making use of traditional CPUs such as those present in processor(s) 830.

In some embodiments, computing system 800 is a computing system made up of one or more computing devices. Computing system 800 may be a distributed computing system, a data processing system, a centralized computing system, a single computer such as a desktop or laptop computer or a networked computing system.

Many different arrangements of the various components depicted, as well as components not shown, are possible without departing from the scope of the claims below. Implementations of the disclosure have been described with the intent to be illustrative rather than restrictive. Alternative implementations will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

For example, in conjunction with specificity requirements and for clarity, the processing performed in a bidirectional GAN was stated in terms of sample, and generally a voxel was an example of a sample. In some embodiments, a sample is a 2-D image or a 2-D portion of an image.

Additionally, the disclosed processes generally are applicable to unsupervised and unpaired data. In an embodiment, training is performed in a supervised manner. In an embodiment, training is performed using paired data.

Furthermore, In an embodiment, a selection of an input object includes a selection of a frame picture in a 3D object, such as a 3D brain scan, and outputting a corresponding picture in a synthesized 3D object that has been produced by 3D synthesis.

An embodiment stores in library 272 predetermined segmentors 436 and 446 that are fixed throughout adversarial generative training. Texture propagation is performed on each class after segmentation.

In an embodiment, a global registry of models and data is stored in database 280 and available through computer 290 through network 230 such as the internet, or the world-wide-web. A user is then able to browse models available in database 280, and to load a model into a synthesizer. A user can perform searches of samples over database 280 and to define a corpus over available samples.

In an embodiment, texture details are preserved by copying low-level feature maps from a deep network that represents an input image, and the adaptation system operates by modeling only upper layers. In an embodiment, the lowest two layers are copied. In an embodiment, the lowest three layers are copied.

In an embodiment, a completed model 224 includes segmentors 436 and 446, generators 422 and 424. Thus a model supports embedded segmentation of both source and target images, and supports forward generation through generator 422 or approximate inverse generation through generator 424.

### EXAMPLES

The first general example is an apparatus for synthesizing images. The apparatus comprising a memory having computer programs stored thereon and a processor configured to perform, when executing the computer programs, operations comprising: generating an output target image from an input source image via a first image generator network that is formed based on texture propagation in a bidirectional generative adversarial network that comprises the first image generator network and a second image generator network which is an approximate inverse of the first image generator network, wherein the formation of the first generative network includes processing performed over a corpus of source samples in a source domain and over a corpus of target samples in a target domain.

This sub-example may include the subject matter of the first general example and any one of its sub-examples, wherein the texture propagation causes a source image to propagate texture details from a source image to a target image by using feature maps of a deep network acting as a descriptor to preserve local textural details at convolutional layers.

This sub-example may include the subject matter of the first general example or any one of its sub-examples, wherein the feature maps comprise feature maps at a layer L modeling features of a target domain sample which are correlated to feature maps at a layer L modeling features of a synthesized source domain sample and feature maps at a layer L modeling features of a source domain sample which are correlated to the feature maps at a layer L modeling features of a synthesized target domain.

This sub-example may include the subject matter of the first general example or any one of its sub-examples, wherein the first image generator network and the second image generator network are iteratively modified in accordance with an entropy loss that comprises a texture entropy loss term that employs a 1-norm.

This sub-example may include the subject matter of the first general example or any one of its sub-examples, wherein the first image generator network is formed based on a shape prior constraint.

This sub-example may include the subject matter of the first general example or any one of its sub-examples, wherein the shape prior constraint extracts shape information from a target domain sample using a target domain segmentor and extracts shape information from a source domain sample using a source domain segmentor.

This sub-example may include the subject matter of the first general example or any one of its sub-examples, wherein the entropy loss further comprises a segmentation cross entropy loss term.

This sub-example may include the subject matter of the first general example or any one of its sub-examples, wherein the segmentation cross entropy loss term calculates cross entropy loss across a set of brain tissue classes comprising at least one of Cerebrospinal Fluid, Gray Matter and White Matter.

This sub-example may include the subject matter of the first general example and any one of its sub-examples, wherein the entropy loss further comprises at least one of a domain matching loss term, a cycle consistency loss term, and a bidirectional loss term.

This sub-example may include the subject matter of the first general example and any one of its sub-examples, wherein the source domain is a first mode of data collection and the target domain is a second and distinct mode of data collection pertaining to subjects with one or more similar attributes.

This sub-example may include the subject matter of the first general example and any one of its sub-examples, wherein a sample comprises a voxel.

Another example may include one or more non-transitory computer-readable media comprising instructions to cause an apparatus, upon execution of the instructions by one or more processors of the apparatus, to perform any one of the operations associated with the first general example and any one of its sub-examples.

Another example may include an apparatus comprising means to perform any one of the operations associated with the first general example and any one of its sub-examples.

Another example may include a method to perform any one of the operations associated with the first general example and any one of its sub-examples.

The second general example comprises a method of training a first image generator network comprising: receiving a corpus of source samples in a source domain and a corpus of target samples in a target domain, forming a first generator network estimate based on texture propagation through bidirectional generative adversarial network estimation using the information contained in the corpus of source samples and in the corpus of target samples.

This sub-example may include the subject matter of the second general example and any one of its sub-examples, wherein the texture propagation causes a source image to propagate texture details from a source image to a target image by using feature maps of a deep network acting as a descriptor to preserve local textural details at convolutional layers.

This sub-example may include the subject matter of the second general example and any one of its sub-examples, wherein the feature maps comprise feature maps at a layer L modeling features of a target domain sample which is correlated to feature maps at a layer L modeling features of a synthesized source domain sample and feature maps at a layer L modeling features of a source domain sample which is correlated to feature maps at a layer L modeling features of a synthesized target domain sample.

This sub-example may include the subject matter of the second general example and any one of its sub-examples, wherein the first image generator network and the second image generator network are iteratively modified in accordance with an entropy loss that comprises a texture entropy loss term that employs a 1-norm.

This sub-example may include the subject matter of the second general example and any one of its sub-examples, wherein the first image generator network estimate is further based on a shape prior constraint, the shape prior constraint extracts shape information from a target domain sample using a target domain segmentor and extracts shape information from a source domain sample using a source domain segmentor, the entropy loss further comprises a segmentation cross entropy loss term that calculates cross entropy loss across a set of brain tissue classes comprising at least one of cerebrospinal fluid, gray matter and white matter.

This sub-example may include the subject matter of the second general example and any one of its sub-examples, wherein the entropy loss further comprises at least one of a domain matching loss, a cycle consistency loss, and a bidirectional loss.

This sub-example may include the subject matter of the second general example and any one of its sub-examples, wherein the source domain is a first mode of data collection and the target domain is a second and distinct mode of data collection pertaining to subjects with one or more similar attributes.

This sub-example may include the subject matter of the second general example and any one of its sub-examples, wherein a sample comprises a voxel.

Another example may include one or more non-transitory computer-readable media comprising instructions to cause a computer, upon execution of the instructions by one or more processors of the computer, to perform the method of the second general example and any one of its sub-examples.

Another example may include an apparatus comprising means to perform the method of the second general example and any one of its sub-examples.

The third general example is an apparatus for synthesizing images, comprising: a first generator configured to operate on an input source image to produce an output target image, the first generator network having been formed by employing texture propagation and a shape prior constraint through the training of a bidirectional generative adversarial network that comprises the first image generator network and a second image generator network which is an approximate inverse of the first image generator network, wherein the first image generator network and the second image generator network are iteratively modified by processing an input voxel in accordance with an entropy loss that comprises a texture entropy loss term and a segmentation cross entropy loss term.

Another example may include one or more non-transitory computer-readable media comprising instructions to cause an apparatus, upon execution of the instructions by one or more processors of the apparatus, to perform any one of the operations associated with the third general example and any one of its sub-examples.

Another example may include an apparatus comprising means to perform any one of the operations associated with the third general example and any one of its sub-examples.

Another example may include a method to perform any one of the operations associated with the third general example and any one of its sub-examples.

Another example may include a process image synthesis as shown and described herein.

Another example may include a system for image synthesis as shown and described herein.

Another example may include a device for image synthesis as shown and described herein.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

What is claimed is:

1. An apparatus for synthesizing images, the apparatus comprising a memory having computer programs stored thereon and a processor configured to perform, when executing the computer programs, operations comprising:
generating a target image in a first imaging modality from a source image in a second imaging modality based on a texture propagation operation in a bidirectional generative adversarial network that comprises a first image generator network and a second image generator network, wherein the second image generator network is an inverse of the first image generator network.

2. The apparatus of claim 1, wherein the texture propagation operation comprises propagating texture details from the source image to the target image by using a plurality of feature maps of a deep network to preserve local textural details at a plurality of convolutional layers of the deep network.

3. The apparatus of claim 2, wherein the plurality of feature maps comprise a first feature map modeling features of a target domain sample, a second feature map modeling features of a synthesized source domain sample, a third feature map modeling features of a source domain sample, and a fourth feature map modeling features of a synthesized target domain.

4. The apparatus of claim 1, wherein the operations further comprising:
iteratively modifying the first image generator network and the second image generator network in accordance with an entropy loss that comprises a texture entropy loss term that employs a 1-norm.

5. The apparatus of claim 4, wherein the entropy loss further comprises a segmentation cross entropy loss term.

6. The apparatus of claim 5, wherein the segmentation cross entropy loss term calculates a cross entropy loss across a set of brain tissue classes including at least one of Cerebrospinal Fluid, Gray Matter, or White Matter.

7. The apparatus of claim 4, wherein the entropy loss further comprises at least one of a domain matching loss term, a cycle consistency loss term, or a bidirectional loss term.

8. The apparatus of claim 1, wherein the bidirectional generative adversarial network is trained based on a shape prior constraint.

9. The apparatus of claim 8, wherein the shape prior constraint comprises target shape information from a target domain, and source shape information from a source domain.

10. The apparatus of claim 9, wherein the source domain is a first mode of data collection and the target domain is a second mode of data collection pertaining to subjects with one or more similar attributes.

11. A method of training a network for synthesizing images, comprising:
receiving a corpus of source samples in a source domain and a corpus of target samples in a target domain; and
forming a generator network estimate based on texture propagation through bidirectional generative adversarial network estimation using information contained in the corpus of source samples and in the corpus of target samples.

12. The method of claim 11, further comprising:
propagating texture details from a source image to a target image based on a descriptor to preserve local textural details at convolutional layers.

13. The method of claim 12, wherein the descriptor comprises a first feature map at a first layer modeling features of a target domain sample, a second feature map at a second layer modeling features of a synthesized source domain sample, a third feature map at a third layer modeling features of a source domain sample, and a fourth feature map at a fourth layer modeling features of a synthesized target domain.

14. The method of claim 11, wherein the network comprises a first image generator network and a second image generator network, and the method further comprising:
iteratively modifying the first image generator network and the second image generator network in accordance with an entropy loss that comprises a texture entropy loss term.

15. The method of claim 11, further comprising:
extracting shape information from a target domain sample using a target domain segmentor and from a source domain sample using a source domain segmentor; and
forming the generator network estimate further based on the shape information.

16. The method of claim 15, wherein the source domain sample comprises a voxel.

17. The method of claim 11, wherein the source domain is a first mode of data collection and the target domain is a second and distinct mode of data collection pertaining to subjects with one or more similar attributes.

18. A system for synthesizing images, comprising:
a generator to operate on a source image to produce a target image, and to propagate texture details from the source image to the target image based on a deep network; and
the deep network to preserve the texture details at convolutional layers of the deep network based on a texture propagation mechanism and a shape prior constraint.

19. The system of claim 18, wherein the generator comprises a first image generator network and a second image generator network, and the first image generator network and the second image generator network are iteratively modified by processing an input voxel in accordance with an entropy loss that comprises a texture entropy loss term and a segmentation cross entropy loss term.

20. The system of claim 18, wherein the shape prior constraint comprises source shape information and target shape information, the system further comprising:
a source domain segmentor to extract the source shape information from a source domain sample; and
a target domain segmentor to extract the target shape information from a target domain sample.
